(19) United States
(12) Patent Application Publication
(10) Pub. No.: US 2024/0054945 A1
(43) Pub. Date: Feb. 15, 2024

(54) Emission Staggering for Low Light or Low Gray Level

(71) Applicant: Apple Inc., Cupertino, CA (US)

(72) Inventors: Mahdi Farrokh Baroughi, Santa Clara, CA (US); Young Don Bae, San Jose, CA (US); Jeongsup Lee, Santa Clara, CA (US); Hari P. Paudel, Milpitas, CA (US); Sunmin Jang, Sunnyvale, CA (US); Shengzhe Jiao, San Diego, CA (US); Nikhil Acharya, Mountain View, CA (US); Yaser Azizi, Santa Clara, CA (US); Ali RostamPisheh, Los Gatos, CA (US); Stanley B. Wang, Cupertino, CA (US); Haitao Li, Mountain View, CA (US)

(21) Appl. No.: 18/365,539

(22) Filed: Aug. 4, 2023

Related U.S. Application Data
(60) Provisional application No. 63/398,195, filed on Aug. 15, 2022.

(51) Int. Cl. G09G 3/32

(52) U.S. Cl. CPC G09G 3/32; G09G 2300/0426; G09G 2310/0248; G09G 2310/08; G09G 2320/0257; G09G 2320/0233

(57) ABSTRACT

An electronic display may include a first anode configured to carry a red emission signal, a second anode configured to carry a blue emission signal, a third anode configured to carry a green emission signal, and a micro-driver configured to stagger a timing of the red emission signal, the blue emission signal, and the green emission signal based on an emission clock signal to display image content on the electronic display.

### CROSS-REFERENCE TO RELATED APPLICATION

This application claims priority to U.S. Patent Application No. 63/398,195, filed on Aug. 15, 2022, titled “Emission Staggering for Low Light or Low Gray Level,” which is hereby incorporated by reference in its entirety for all purposes.

### SUMMARY

The present disclosure relates generally to display pixels illuminated in pulses and, more particularly, to staggering a timing of emission signals of the display pixels to mitigate capacitive coupling between display pixel anodes.

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Electronic displays may display image content that present visual representations of information. Accordingly, numerous electronic systems—such as computers, mobile phones, portable media devices, tablets, televisions, virtual-reality headsets, and vehicle dashboards, among many others—often include or use electronic displays. An electronic display may include many thousands to millions of display pixels. In any case, an electronic display may generally display an image by actively controlling light emission (e.g., luminance) from its display pixels.

An electronic display may take a variety of forms. For example, an electronic display may be an organic light-emitting diode (OLED) display or a micro light emitting display (μ-LED) display. An electronic display may include display driver circuitry and an active area having a matrix of display pixels connected to cathodes and anodes. For example, a subset of display pixels may be located on each anode. In order for the electronic display to achieve high resolution, the anodes may be positioned in close proximity. The anodes may cause the display pixels to emit a light to display the image content. However, the close proximity of the anodes may cause capacitive coupling, and emission signals of the display pixels may transfer. As such, the resulting image content may have an undesirable luminance shift that varies based on a length of the emission signal.

In certain conditions, the resulting image content on the display may have a luminance shift that appears as a content-dependent image artifact. In low light or low gray level conditions, the emission signal of the display pixels may be short, thus small amounts of charge transferred to and from the emission signal may produce a comparatively noticeable change in luminance. In other words, capacitive coupling in low light or low gray level conditions may cause image artifacts. However, in brighter light conditions, the emission signal of the display pixels may be longer in order to generate image content at the desired brighter luminance. Longer emission signals may be less susceptible to charge transfer; as such, there may be little or no noticeable change in luminance.

Accordingly, the present disclosure provides systems and techniques for mitigating capacitive coupling between anodes by staggering the timing of emission signals. More specifically, the present disclosure provides systems and techniques for reducing or eliminating image artifacts at low light or low gray level conditions due to capacitive coupling. For example, the display pixels may display a frame of brighter image content (e.g., high gray level) with longer emission signals while the display pixels may display a frame of dimmer image content (e.g., low gray light) with shorter emission signals. Additionally or alternatively, at low light conditions, the emission signals of the display pixels may be shorter (e.g., shorter pulse-width). With shorter emission signals, the emission signals may be staggered over time with little or no overlap. In this way, the emission signals of the display pixels may not overlap, thereby reducing or eliminating charge transfer or capacitive coupling. As such, image artifacts due to luminance shifts may be reduced or eliminated.

At higher brightness conditions (e.g., higher luminance), the emissions signals of the display pixels may be longer (e.g., longer pulse width) to reach the desired luminance. As such, staggering the timing of the emission signals may still result in overlap between the signals, causing a small amount of charge transfer due to capacitive coupling between the anodes. However, at higher brightness conditions, the charge transfer may be small in comparison to the length of the emission signal, thus the relative luminance shift may be small or unnoticeable. As such, staggering the timing of emission signals of neighboring display pixels may reduce or eliminate the appearance of image artifacts at low light or low gray level conditions without causing image artifacts at higher brightness conditions.

In an embodiment, the emission signals of the display pixels may be staggered by color (e.g., red, green, blue). For example, adjacent anodes may each be associated with a color channel. For example, a first anode may be associated with a red channel, a second anode may be associated with a green channel, and a third anode may be associated with a blue channel. As such, the first anode may create red emission signals, the second anode may create green emission signals, and the third anode may create blue emission signals via the display pixels. The emission signals may be staggered such that the red emission signal and the blue emission signal start and finish at a similar time, then the green emission signal may start and finish at a later time. In this way, the red and blue emission signals may not capacitively couple due to the location of the first anode and the third anode, and the green emission signal may not capacitively couple due to the staggered timing. In another embodiment, the red emission signals may start and finish, followed by the blue emission signals, and lastly the green emission signals. Due to the staggered timing, the emission signals may not overlap, therefore reducing or eliminating charger transfer. Still in another embodiment, the first anode may create red emission signals while the second anode and the third anode are precharged with a voltage. In other words, the red emission signals may start before the blue emission signals or the green emission signals. When the red emission signals finish, the blue emission signals may start and finish, followed by the green emission signals. With the staggered timing of emission signals and voltage precharge, the emission signals may not capacitively couple, thereby reducing or eliminating the presence of luminance shifts and image artifacts.

### BRIEF DESCRIPTION OF THE DRAWINGS

Various aspects of this disclosure may be better understood upon reading the following detailed description and upon reference to the drawings in which:

FIG. 1 is a block diagram of an electronic device with an electronic display, in accordance with an embodiment of the present disclosure;

FIG. 2 is a front view of a handheld device representing another embodiment of the electronic device of FIG. 1;

FIG. 3 is a front view of another handheld device representing another embodiment of the electronic device of FIG. 1;

FIG. 4 is a perspective view of a notebook computer representing an embodiment of the electronic device of FIG. 1;

FIG. 5 is a front view and side view of a wearable electronic device representing another embodiment of the electronic device of FIG. 1;

FIG. 6 is a front view of a desktop computer representing another embodiment of the electronic device of FIG. 1;

FIG. 7 is a block diagram of a micro-LED display that employs micro-drivers to drive display pixels with controls signals, in accordance with an embodiment of the present disclosure;

FIG. 8 is a block diagram schematically illustrating an operation of a micro-driver of FIG. 7, in accordance with an embodiment of the present disclosure;

FIG. 9 is a timing diagram illustrating an example operation of the micro-driver of FIG. 8, in accordance with an embodiment of the present disclosure;

FIG. 10 is a schematic illustration of the micro-LED display of FIG. 7, where a micro-driver controls a collection of anodes and display pixels based on a digital code, in accordance with an embodiment of the present disclosure;

FIG. 11 is a circuit view of the micro-LED display of FIG. 7, where capacitive coupling between the anodes may be present, in accordance with an embodiment of the present disclosure;

FIG. 12 is a graph illustrating example emission signals of the anodes over time with and without staggered emission timing, in accordance with an embodiment of the present disclosure;

FIG. 13 is a block diagram schematically illustrating image content displayed on the micro-LED display of FIG. 7 with and without staggered emission timing, in accordance with an embodiment of the present disclosure;

FIG. 14 is a timing diagram illustrating an example staggered emission timing of the anodes based on the digital code in low light or low gray level conditions, in accordance with an embodiment of the present disclosure;

FIG. 15 is a timing diagram illustrating an example staggered emission timing of the anodes with precharge based on the digital code in low light or low gray level conditions, in accordance with an embodiment of the present disclosure;

FIG. 16 is a timing diagram illustrating an example staggered emission timing of the anodes based on the digital code in brighter light conditions, in accordance with an embodiment of the present disclosure;

FIG. 17 is a timing diagram illustrating an example staggered emission timing of the anodes with precharge based on the digital code in brighter light conditions, in accordance with an embodiment of the present disclosure;

FIG. 18 is a graph illustrating a pulse width of the emissions of the anodes, in accordance with an embodiment of the present disclosure;

FIG. 19 is a flow chart illustrating an example process for staggering clock emission signals, in accordance with an embodiment of the present disclosure; and

FIG. 20 is a flow chart illustrating an example process for staggering a red emission signal, a blue emission signal, and a green emission signal, in accordance with an embodiment of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the phrase A “based on” B is intended to mean that A is at least partially based on B. Moreover, the term “or” is intended to be inclusive (e.g., logical OR) and not exclusive (e.g., logical XOR). In other words, the phrase A “or” B is intended to mean A, B, or both A and B.

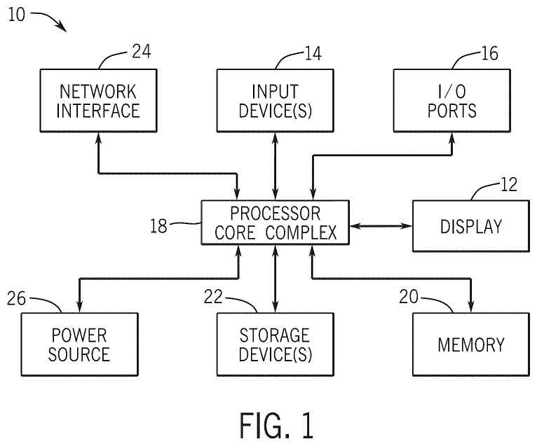

With the preceding in mind and to help illustrate, an electronic device 10 including an electronic display 12 is shown in FIG. 1. As is described in more detail below, the electronic device 10 may be any suitable electronic device, such as a computer, a mobile phone, a portable media device, a tablet, a television, a virtual-reality headset, a wearable device such as a watch, a vehicle dashboard, or the like. Thus, it should be noted that FIG. 1 is merely one example of a particular implementation and is intended to illustrate the types of components that may be present in an electronic device 10.

The electronic device 10 includes the electronic display 12, one or more input devices 14, one or more input/output (I/O) ports 16, a processor core complex 18 having one or more processing circuitry(s) or processing circuitry cores, local memory 20, a main memory storage device 22, a network interface 24, and a power source 26 (e.g., power supply). The various components described in FIG. 1 may include hardware elements (e.g., circuitry), software elements (e.g., a tangible, non-transitory computer-readable medium storing executable instructions), or a combination of both hardware and software elements. It should be noted that the various depicted components may be combined into fewer components or separated into additional components. For example, the local memory 20 and the main memory storage device 22 may be included in a single component.

The processor core complex 18 is operably coupled with local memory 20 and the main memory storage device 22. Thus, the processor core complex 18 may execute instructions stored in local memory 20 or the main memory storage device 22 to perform operations, such as generating or transmitting image data to display on the electronic display 12. As such, the processor core complex 18 may include one or more general purpose microprocessors, one or more application specific integrated circuits (ASICs), one or more field programmable logic arrays (FPGAs), or any combination thereof.

In addition to program instructions, the local memory 20 or the main memory storage device 22 may store data to be processed by the processor core complex 18. Thus, the local memory 20 and/or the main memory storage device 22 may include one or more tangible, non-transitory, computer-readable media. For example, the local memory 20 may include random access memory (RAM) and the main memory storage device 22 may include read-only memory (ROM), rewritable non-volatile memory such as flash memory, hard drives, optical discs, or the like.

The network interface 24 may communicate data with another electronic device or a network. For example, the network interface 24 (e.g., a radio frequency system) may enable the electronic device 10 to communicatively couple to a personal area network (PAN), such as a Bluetooth network, a local area network (LAN), such as an 802.11x Wi-Fi network, or a wide area network (WAN), such as a 4G, Long-Term Evolution (LTE), or 5G cellular network. The power source 26 may provide electrical power to one or more components in the electronic device 10, such as the processor core complex 18 or the electronic display 12. Thus, the power source 26 may include any suitable source of energy, such as a rechargeable lithium polymer (Li-poly) battery or an alternating current (AC) power converter. The I/O ports 16 may enable the electronic device 10 to interface with other electronic devices. For example, when a portable storage device is connected, the I/O port 16 may enable the processor core complex 18 to communicate data with the portable storage device.

The input devices 14 may enable user interaction with the electronic device 10, for example, by receiving user inputs via a button, a keyboard, a mouse, a trackpad, or the like. The input device 14 may include touch-sensing components in the electronic display 12. The touch sensing components may receive user inputs by detecting occurrence or position of an object touching the surface of the electronic display 12.

In addition to enabling user inputs, the electronic display 12 may include a display panel with one or more display pixels. The electronic display 12 may control light emission from the display pixels to present visual representations of information, such as a graphical user interface (GUI) of an operating system, an application interface, a still image, or video content, by displaying frames of image data. To display images, the electronic display 12 may include display pixels implemented on the display panel. The display pixels may represent sub-pixels that each control a luminance value of one color component (e.g., red, green, or blue for an RGB pixel arrangement or red, green, blue, or white for an RGBW arrangement).

The electronic display 12 may display an image by controlling light emission from its display pixels based on pixel or image data associated with corresponding image pixels (e.g., points) in the image. In some embodiments, pixel or image data may be generated by an image source, such as the processor core complex 18, a graphics processing unit (GPU), or an image sensor. Additionally, in some embodiments, image data may be received from another electronic device 10, for example, via the network interface 24 and/or an I/O port 16. Similarly, the electronic display 12 may display frames based on pixel or image data generated by the processor core complex 18, or the electronic display 12 may display frames based on pixel or image data received via the network interface 24, an input device, or an I/O port 16.

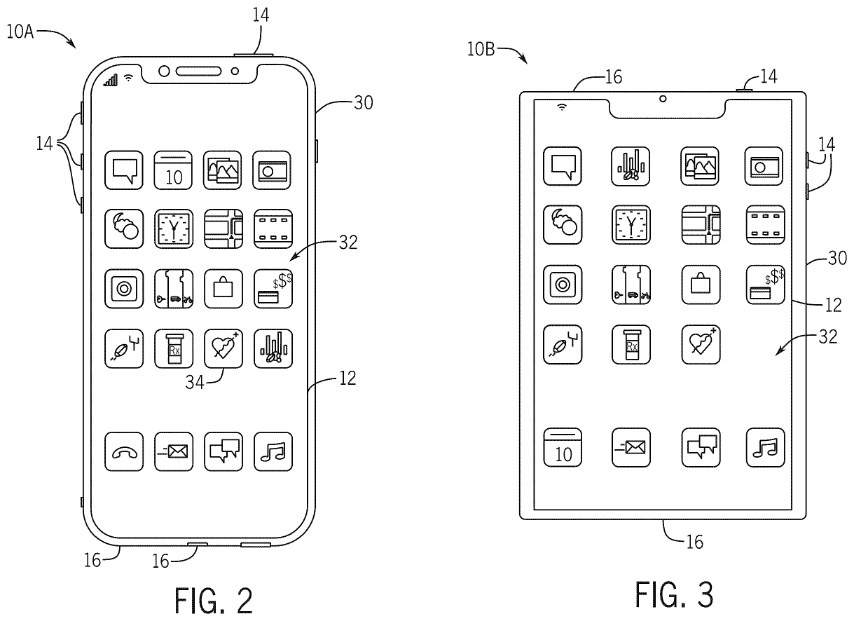

The electronic device 10 may be any suitable electronic device. To help illustrate, an example of the electronic device 10, a handheld device 10A, is shown in FIG. 2. The handheld device 10A may be a portable phone, a media player, a personal data organizer, a handheld game platform, or the like. For illustrative purposes, the handheld device 10A may be a smart phone, such as any iPhone® model available from Apple Inc.

The handheld device 10A includes an enclosure 30 (e.g., housing). The enclosure 30 may protect interior components from physical damage or shield them from electromagnetic interference, such as by surrounding the electronic display 12. The electronic display 12 may display a graphical user interface (GUI) 32 having an array of icons. When an icon 34 is selected either by an input device 14 or a touch-sensing component of the electronic display 12, an application program may launch.

The input devices 14 may be accessed through openings in the enclosure 30. The input devices 14 may enable a user to interact with the handheld device 10A. For example, the input devices 14 may enable the user to activate or deactivate the handheld device 10A, navigate a user interface to a home screen, navigate a user interface to a user-configurable application screen, activate a voice-recognition feature, provide volume control, or toggle between vibrate and ring modes.

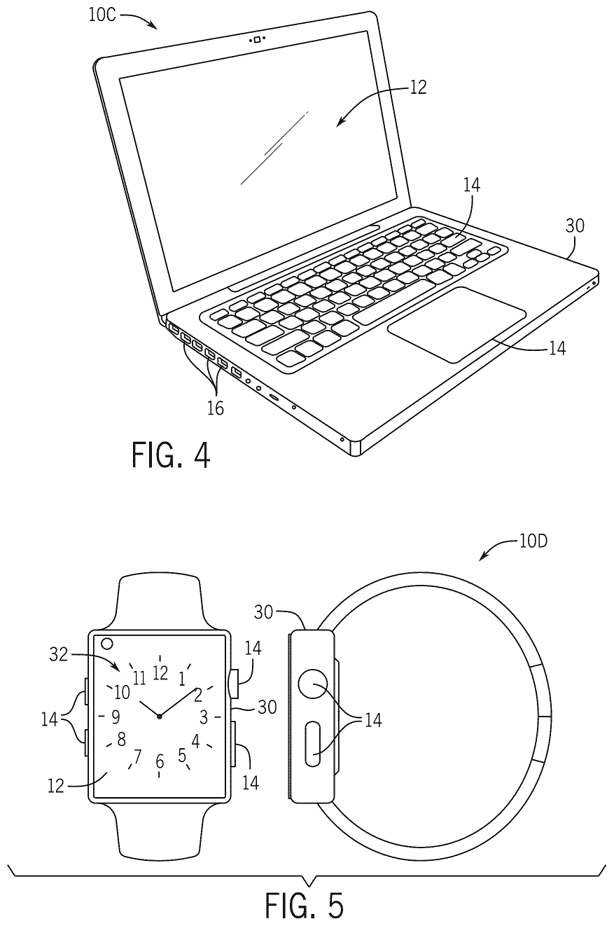

Another example of a suitable electronic device 10, specifically a tablet device 10B, is shown in FIG. 3. The tablet device 10B may be any iPad® model available from Apple Inc. A further example of a suitable electronic device 10, specifically a computer 10C, is shown in FIG. 4. For illustrative purposes, the computer 10C may be any MacBook® or iMac® model available from Apple Inc. Another example of a suitable electronic device 10, specifically a watch 10D, is shown in FIG. 5. For illustrative purposes, the watch 10D may be any Apple Watch® model available from Apple Inc. As depicted, the tablet device 10B, the computer 10C, and the watch 10D each also includes an electronic display 12, input devices 14, I/O ports 16, and an enclosure 30. The electronic display 12 may display a GUI 32. Here, the GUI 32 shows a visualization of a clock. When the visualization is selected either by the input device 14 or a touch-sensing component of the electronic display 12, an application program may launch, such as to transition the GUI 32 to presenting the icons 34 discussed in FIGS. 2 and 3.

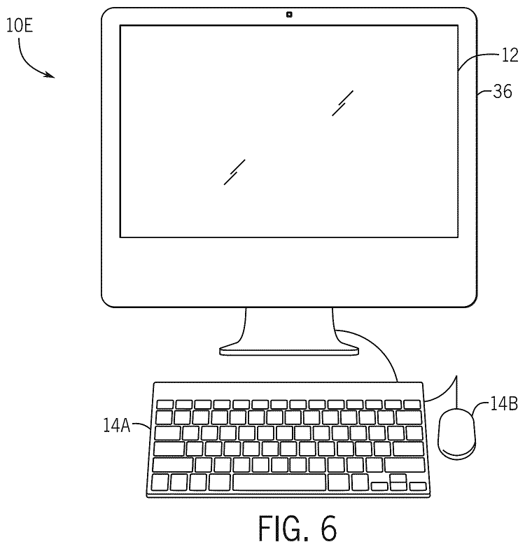

Turning to FIG. 6, a computer 10E may represent another embodiment of the electronic device 10 of FIG. 1. The computer 10E may be any computer, such as a desktop computer, a server, or a notebook computer, but may also be a standalone media player or video gaming machine. By way of example, the computer 10E may be an iMac®, a MacBook®, or other similar device by Apple Inc. of Cupertino, California. It should be noted that the computer 10E may also represent a personal computer (PC) by another manufacturer. A similar enclosure 36 may be provided to protect and enclose internal components of the computer 10E, such as the electronic display 12. In certain embodiments, a user of the computer 10E may interact with the computer 10E using various peripheral input structures 14, such as the keyboard 14A or mouse 14B (e.g., input structures 14), which may connect to the computer 10E.

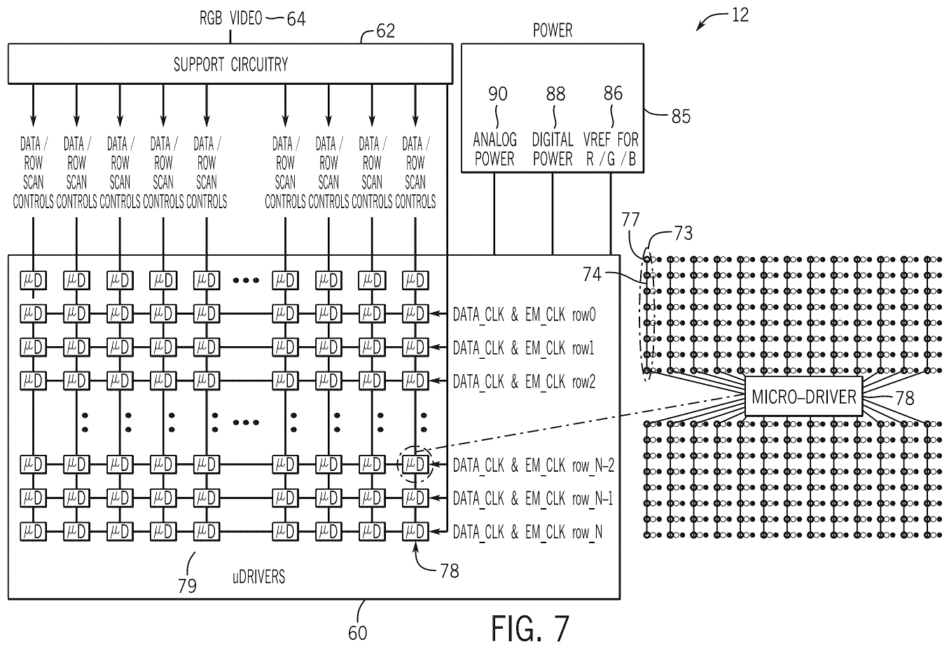

FIG. 7 depicts a block diagram of an example architecture of the electronic display 12 (e.g., micro-LED display 12). In the example of FIG. 7, the micro-LED display 12 uses an RGB display panel 60 with pixels that include red, green, and blue micro-LEDs as display pixels. Support circuitry 62 may receive RGB-format video image data 64. It should be appreciated, however, that the micro-LED display 12 may display other formats of image data, in which case the support circuitry 62 may receive image data of such different image format. In some embodiments, the support circuitry 62 may include a video timing controller (video TCON) and/or emission timing controller (emission TCON) that receives and uses the image data 64 in a serial bus to determine a data clock signal (DATA_CLK) and/or a emission clock signal (EM_CLK) to control the provision of the image data 64 in the micro-LED display 12. The video TCON may also pass the image data 64 to a serial-to-parallel circuitry that may deserialize the image data 64 signal into several parallel image data signals. That is, the serial-to-parallel circuitry may collect the image data 64 into the particular data signals that are passed on to specific columns among a total of M respective columns in the display panel 60. As noted above, the video TCON may generate the data clock signal (DATA_CLK), and the emission TCON may generate the emission clock signal (EM_CLK). In certain instances, support circuitry 62 may stagger the emission clock signal (EM_CLK) for a red emission clock, a blue emission clock, a green emission clock, or the like. Collectively, these may be referred to as Data/Row Scan Control signals, as illustrated in FIG. 7. As such, the data is labeled DATA/ROW SCAN CONTROLS. The data/row scan controls respectively contain image data corresponding to pixels in the first column, second column, third column, fourth column . . . fourth-to-last column, third-to-last column, second-to-last column, and last column, respectively. The data/row scan controls may be collected into more or fewer columns depending on the number of columns that make up the display panel 60.

In particular, the display panel 60 columns include micro-drivers 78. The micro-drivers 78 are arranged in an array 79. The micro-drivers 78 may receive and/or pass on various signals sent from the support circuitry 62. By way of example, micro-drivers 78 on the left-hand side of the display may receive row scan control signals and pass those signals that correspond to its particular row to other micro-drivers 78 in that row of micro-drivers. Each micro-driver 78 drives a number of display pixels 77. Different display pixels (e.g., display sub-pixel) 77 may include different colored micro-LEDs (e.g., a red micro-LED, a green micro-LED, or a blue micro-LED) to represent the image data 64 in RGB format. Although one of the micro-drivers 78 of FIG. 7 is shown to drive twenty-six anodes 73 having eight display pixels 77 each, each micro-driver 78 may drive more or fewer anodes 73 (e.g., 8 anodes, 9 anodes, 10 anodes, 11 anodes, 12 anodes, 14 anodes, 15 anodes, 16 anodes, 17 anodes, 18 anodes, and so forth) and respective display pixels 77. As illustrated, the subset of display pixels 77 located on each anode 73 may be associated with a particular color (e.g., red, green, or blue). For example, a first set of anodes 73 corresponds to a red color channel (e.g., subset of red display pixels 77). There may be a second set of anodes 73 that couple to a green color channel (e.g., subset of green display pixels 77) and a third set of anodes 73 that couple to a blue color channel (subset of blue display pixels 77), but these are not expressly illustrated in FIG. 7 for ease of illustration. As mentioned above, it should be noted that a respective cathode corresponds to a subset of display pixels 77 associated with a particular color even though each cathode for a particular color channel is not illustrated in FIG. 7.

A power supply 85 may provide a reference voltage (VREF) 86 to drive the micro-LEDs, a digital power signal 88, and an analog power signal 90. In some cases, the power supply 85 may provide more than one reference voltage (VREF) 86 signal. Namely, display pixels 77 of different colors may be driven using different reference voltages. As such, the power supply 85 may provide more than one reference voltage (VREF) 86. Additionally or alternatively, other circuitry on the display panel 60 may step the reference voltage (VREF) 86 up or down to obtain different reference voltages to drive different colors of micro-LED.

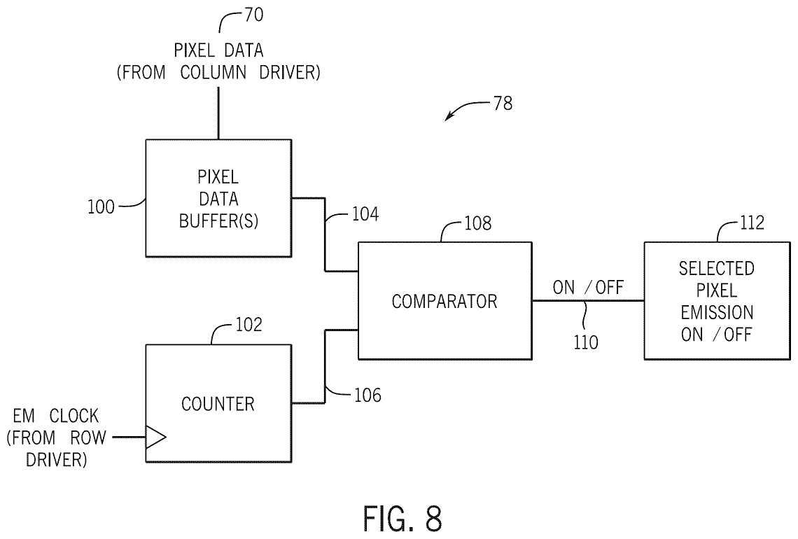

A block diagram shown in FIG. 8 illustrates some of the components of one of the micro-drivers 78. The micro-driver 78 shown in FIG. 8 includes pixel data buffer(s) 100 and a digital counter 102. The pixel data buffer(s) 100 may include sufficient storage to hold image data 70 that is provided (e.g., as a digital code). For instance, the micro-driver 78 may include pixel data buffers to store image data 70 for a display pixel 77 at any one time (e.g., for 8-bit image data 70, this may be 24 bits of storage). It should be appreciated, however, that the micro-driver 78 may include more or fewer buffers, depending on the data rate of the image data 70 and the number of display pixels 77 included in the image data 70. The pixel data buffer(s) 100 may take any suitable logical structure based on the order that the column driver 74 provides the image data 70. For example, the pixel data buffer(s) 100 may include a first-in-first-out (FIFO) logical structure or a last-in-first-out (LIFO) structure.

When the pixel data buffer(s) 100 has received and stored the image data 70, the micro-driver 78 may provide the emission clock signal (EM_CLK). A counter 102 may receive the emission clock signal (EM_CLK) as an input. The pixel data buffer(s) 100 may output enough of the stored image data 70 to output a digital data signal 104 representative of a desired gray level for a particular display pixel 77 that is to be driven by the micro-driver 78. The counter 102 may also output a digital counter signal 106 indicative of the number of edges (only rising, only falling, or both rising and falling edges) of the emission clock signal (EM_CLK) 98. The signals 104 and 106 may enter a comparator 108 that outputs an emission control signal 110 in an “on” state when the signal 106 does not exceed the signal 104, and an “off” state otherwise. The emission control signal 110 may be routed to driving circuitry (not shown) to the anode associated with the display pixel 77 being driven. For example, the emission control signal 110 may be driven through the anode 73 to cause light emission 112 from the selected display pixel 77 to be on or off. The longer the display pixel 77 emits the light (e.g., longer pulse width), a greater amount of light may be perceived by the viewer. Indeed, a longer time the selected display pixel 77 is driven “on” by the emission control signal 110, a greater the amount of light will be perceived by the human eye as originating from the display pixel 77.

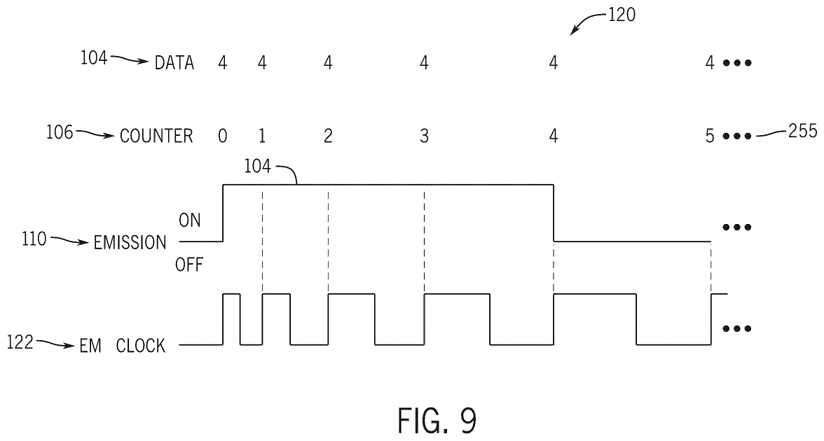

A timing diagram 120, shown in FIG. 9, provides one brief example of the operation of the micro-driver 78. The timing diagram 120 shows the digital data signal 104, the digital counter signal 106, the emission control signal 110, and the emission clock signal (EM_CLK) represented by numeral 122. In the example of FIG. 9, the gray level for driving the selected display pixel 77 is gray level 4, and this is reflected in the digital data signal 104. The emission control signal 110 drives any selected display pixels 77 “on” for a period of time defined as gray level 4 based on the emission clock signal (EM_CLK). Namely, as the emission clock signal (EM_CLK) rises and falls, the digital counter signal 106 gradually increases. The comparator 108 outputs the emission control signal 110 to an “on” state as long as the digital counter signal 106 remains less than the data signal 104. When the digital counter signal 106 reaches the data signal 104, the comparator 108 outputs the emission control signal 110 to an “off” state, thereby causing the selected anode 73 and thereby causing the selected display pixel 77 to no longer to emit light.

It should be noted that the steps between gray levels are reflected by the steps between emission clock signal (EM_CLK) edges. That is, based on the way humans perceive light, to notice the difference between lower gray levels (e.g., low light or low gray level conditions), the difference between the amounts of light emitted between two lower gray levels may be relatively small. To notice the difference between higher gray levels under bright light conditions, however, the difference between the amounts of light emitted between two higher gray levels may be comparatively much greater. The emission clock signal (EM_CLK) therefore may use relatively short time intervals between clock edges at first. To account for the increase in the difference between light emitted as gray levels increase, the differences between edges (e.g., periods) of the emission clock signal (EM_CLK) may gradually lengthen, thereby increasing the pulse width of the emission signals of the anodes 73. The particular pattern of the emission clock signal (EM_CLK), as generated by the emission TCON, may have increasingly longer differences between edges (e.g., periods) so as to provide a gamma encoding of the gray level of the display pixel 77 being driven.

For example, the emission clock signal (EM_CLK) may be staggered, thereby staggering the timing of the emission signals (e.g., red emission signal, blue emission signal, green emission signal). The emission clock signal (EM_CLK) may stagger the timing of emission signals based on a luminance or brightness condition. For example, based on the data signal 104, the emission clock signal (EM_CLK) may be staggered. In certain instances, the data signal 104 may be indicative of a low gray level, which may cause the emission clock signal (EM_CLK) to be staggered.

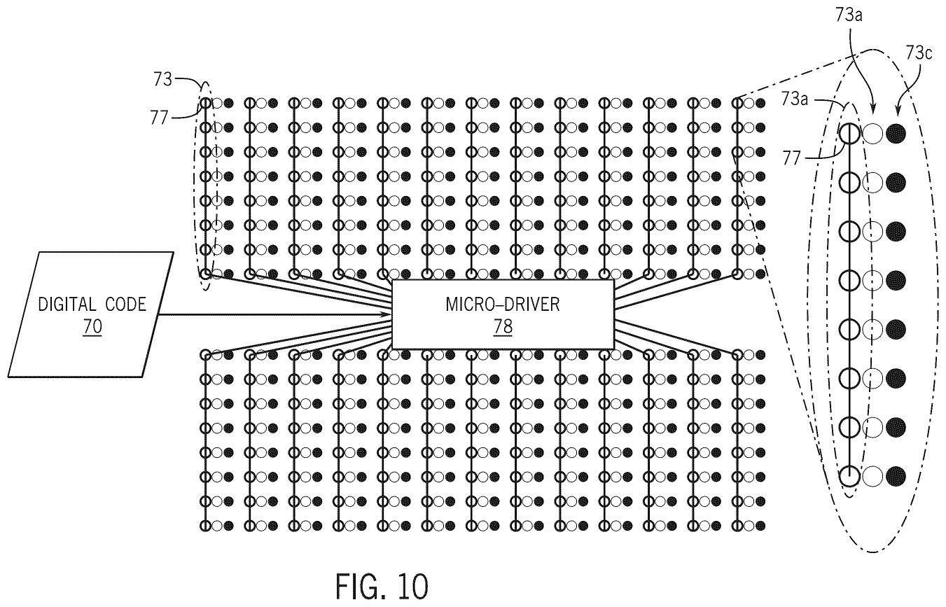

With the preceding in mind, FIG. 10 illustrates the micro-driver 78 driving the display pixels 77 according to the image data 70 in the form of a digital code, and thereby enabling image content to be displayed by the micro-LED display 12. As mentioned above, the micro-driver 78 may drive any suitable number of display pixels 77, and a subset of display pixels 77 may be located on respective anodes 73 of the micro-LED display 12. As illustrated, the subset of display pixels 77 located on each anode 73 may be associated with a particular color (e.g., red, green, blue). For example, a first anode 73a may be associated with a red color channel and create, via the display pixels 77, red emission signals (e.g., light emissions 112), a second anode 73b may be associated with a green color channel and create, via the display pixels 77 green emission signals, and a third anode 73c may be associated with a blue color channel and create, via the display pixels 77 blue emission signals. Further, it should be noted that a respective cathode corresponds to a subset of display pixels 77 associated with a particular color even though each cathode for a particular color channel is not illustrated in FIG. 10. For example, as illustrated, a first set of cathodes corresponds to a red color channel (e.g., subset of red display pixels 77). However, there may be a second set of cathodes that couple to a green color channel (e.g., subset of green display pixels 77) and a third set of cathodes that couple to a blue color channel (subset of blue display pixels 77). The second set of cathodes and the third set of cathodes are not expressly illustrated in FIG. 10 for ease of illustration.

In certain embodiments, the micro-LED display 12 may include the display pixels 77 driven by two micro-drivers 78. A first micro-driver 78a may be located at a top edge of the micro-LED display 12 and a second micro-driver 78b may be located at a bottom edge of the micro-LED display 12. Due to the close proximity of the anodes 73, drawing current and/or a voltage may also result in capacitive coupling between the anodes. Additionally or alternatively, display pixels 77 may be associated with the anodes 73 and also located in close proximity. As the display pixels 77 emit signals, charge may be transferred between the signals resulting in crosstalk.

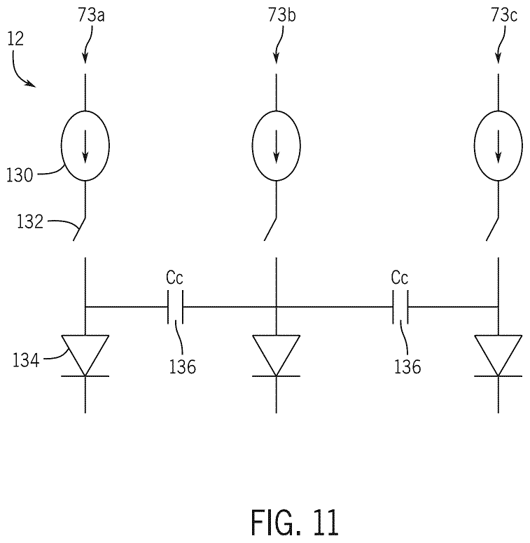

With the foregoing in mind, FIG. 11 illustrates a circuit view of the micro-LED display 12 with one or more anodes 73. For example, a first anode 73a may include a current source 130, a switch 132, and one or more light emissive elements 134 (e.g., OLED, micro-LED). For example, the anodes 73 may be associated with eight micro-LEDs that emit light based on the digital code 70 to turn “on” or “off” an associated display pixel 77. The current source 130 may provide a current across the light emissive element 134 via the anode 73. The switch 132 may connect or disconnect a conductive path along the anode 73 based on the digital code 70. By allowing current to flow across the light emissive element 134, the corresponding display pixel 77 may emit a voltage corresponding to the emission signal (e.g., light signal), while disconnecting the conducting path may not cause the corresponding display pixel 77 to remain dark. To achieve high resolution, the anodes 73a, 73b, 73c may be placed in close proximity. For example, the first anode 73a may be directly adjacent the second anode 73b, which may be directly adjacent to the third anode 73c. Placing the anodes 73 directly adjacent may cause capacitive coupling 136 between the anodes 73 when current or voltage flows across the anodes 73. Additionally or alternatively, when the display pixels 77 emit a signal, the capacitive coupling 136 may occur. The capacitance coupling 136 between the anodes 73 may be between 50 to 70 femtofarad (fF). The amount of capacitance coupling 136 may be influenced by the properties of the micro-LED display 12, a location of the anode 73 within the micro-LED display 12, a total number of anodes 73, a rod material of the anode 73, a total current drawn by the anodes 73, the luminance of the image content, or the like. The capacitance coupling 136 between the anodes 73 may influence the emission signal of the display pixels 77, thereby causing image artifacts within the image content of the micro-LED display 12.

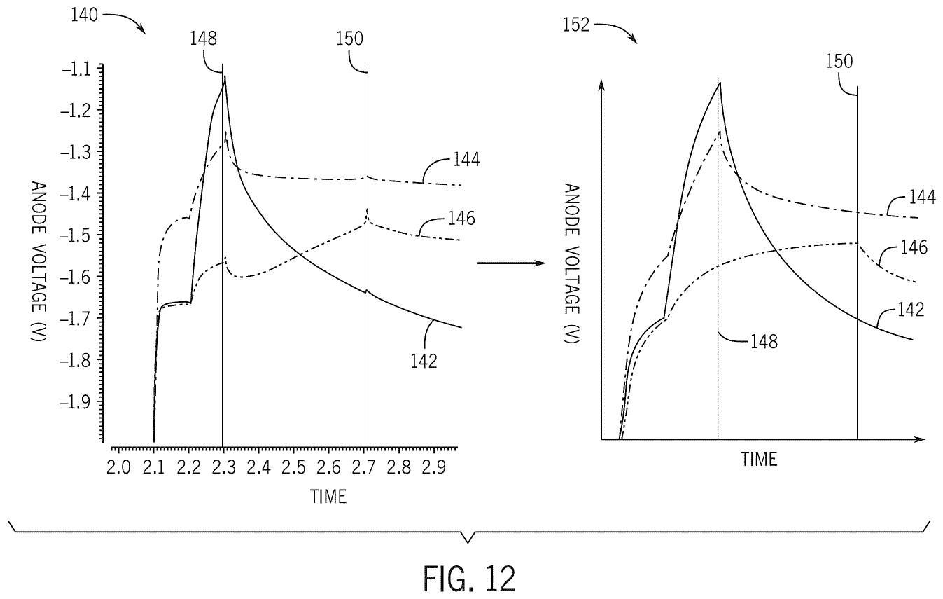

FIG. 12 illustrates the emission signal (represented as an anode voltage) of the display pixels 77 over time. For example, a graph 140 illustrates the anode voltage over time of different color channels (e.g., red, blue, green). Each color channel per local passive matrix may include multiple anodes for the color, such as sixteen red anodes, sixteen blue anodes, and sixteen green anodes. However, as described herein, 8, 9, 10, 11, 12, 14, 15, 17, 18 or any suitable number of anodes may be within the micro-LED display 12. Based on the digital code 70, each anode 73 may carry an emission signal and cause the associated display pixel 77 to create a red emission signal, a blue emission signal, or a green emission signal, respectively. For example, the red emission signals and blue emission signals may first start and end, then the green emission signals may start.

Before continuing, several terms that will be used in this disclosure will be described. The emission signals from the display pixels 77 associated with a red anode may be described as red emission signals, the emission signals display pixels 77 associated with a green anode may be described as green emission signals, and the emission signals from the display pixels 77 associated with a blue anode may be described as blue emission signals. Further, the emission signals may be associated with anode voltage and/or an amount of anode voltage provided to the light emissive unit causing the associated display pixel 77 to display the light emission. The length of the emission signal may be for a period of time, but may also be referred to as a pulse width. The pulse width of the emission signal may be the amount of time for one cycle, or one emission signal, to start and end. A longer pulse width may correspond to a higher luminance or brighter light conditions of the image content, while a shorter pulse width may correspond to a lower luminance or lower light conditions of the image content. Further, low light, low gray level, and brighter light conditions may refer to the luminance of the image content being displayed on the micro-LED display 12. By way of example, low light conditions may be approximately 450 millinits (mits) or less, which may be equivalent to a pulse width of 0.5 uS or less, while brighter light conditions may be greater than approximately 450 mnits. The display pixels 77 may be driven to emit signals based on the digital code 70, the emission control signal 110, or a combination thereof.

Returning to the graph 140, a line 142 may represent the anode voltage creating the red emission signals, a line 144 may represent the anode voltage creating the blue emission signals, and a line 146 may represent the anode voltage creating the green emission signals. Each of the lines 142, 144, and 146 may include a wide distribution of lines, which may be representative of nonuniformity of emission signals by display pixels 77 associated with the same color channel. For example, as represented by lines 142 and 144, the red emission signals and the blue emission signals may have a similar pulse width. At point 148, lines 142 and 144 illustrate a peak in anode voltage followed by a decay in the anode voltage, which may be indicative of emitting light. At point 148, the line 144 includes a distribution of anode voltages from different anodes 73, which may be indicative of differing capacitive coupling to the blue emission signals. Capacitive coupling between the anodes 73 of the red channel and the anodes 73 of the blue channel may occur at differing amounts, causing the nonuniformity of the emission signals at point 148 of line 144.

During this time period, the green emission signals may be most impacted by the red emission signals and the blue emission signals. For example, the line 146 includes a peak at point 148 with a wide distribution of anode voltages, which may be indicative of capacitive coupling between the anodes 73 of the green channel with the anodes 73 of the red channel and the anodes 73 of the blue channel. Between points 148 and 150, the line 146 may linearly increase, which may be indicative of a second green emission signal before the anode voltage starts to decay.

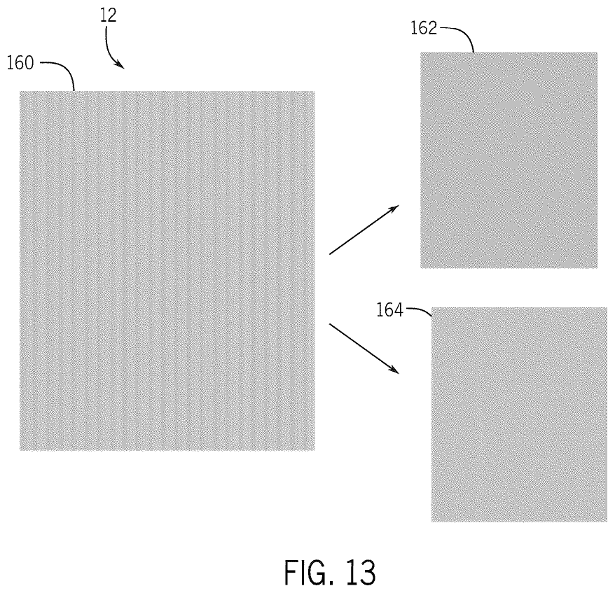

At point 150, lines 142 and 144 also include a small peak, representative of capacitive coupling due to the green emission signals. For example, as the display pixels 77 of the green channel create the green emission signal and charge from the emission signal may transfer to the red emission signal and the blue emission signal. In other words, cross-talk may occur between the green emission signal and the red emission signal and the blue emission signal. As further described with reference to FIG. 13, when the image content may be a flat field or a certain color, the cross-talk between the display pixels 77 may cause non-uniformity or image artifacts, such as repeating vertical lines. Indeed, the cross-talk may cause a luminance shift resulting in image artifacts.

To reduce or eliminate image artifacts due to capacitive coupling, a timing of the emission signals may be staggered. For example, a graph 152 illustrates the lines 142, 144, and 146, which correspond to red emission signal, the blue emission signal, and the green emission signal, respectively. For example, the red emission signal and the blue emission signal may start immediately, such as time t=0, while the green emission signal may be staggered (e.g., delayed). The lines 142 and 144 illustrate the red emission signal and the blue emission signal starting at an initial voltage of zero and reaching a peak anode voltage at point 148, which may be indicative of voltage driven from the respective anode 73. However, the line 146 illustrates the green emission signal not starting emissions until point 150. Indeed, the line 146 appears smooth for a period of time until point 150. At point 150, the lines 142 and 144 illustrate a decaying anode voltage for the red emission signal and the blue emission signal, without capacitive coupling. In other words, capacitive coupling may be reduced or eliminated by delaying the timing of the green emission signal.

In certain instances, such as low light or low gray level conditions, the image content displayed by the micro-LED display 12 may include image artifacts such as repeating or random vertical lines due to capacitive coupling between the anodes 73. The capacitive coupling may stem from adjacent positioning of anodes 73, charge transfer from emission signals of the display pixels 77, imbalance in anode capacitance, imbalance in display pixel capacitance, imbalance in spline capacitance (e.g., capacitance at spline borders), and so forth.

Further, at low light or low gray level conditions, pulse widths (e.g., length) of the emission signals may be short, as such influences to the emission signals may be visible within the image content. In this way, impacts to the emission signal may result in image artifacts within the image content. At brighter light conditions, such as brighter image content, pulse widths of the emission signals may be long, as such changes to the luminance may not be visible. The relationship between emission signals of the display pixels and the luminance of the image content may be an inverse relationship.

Such capacitive coupling may be corrected as depicted in FIG. 13. Without staggering timing of the emission signals, in low light or low gray level conditions, image artifacts due to capacitive coupling between the anodes 73, such as repeating vertical lines appear could appear when image content 160 is displayed on the micro-LED display 12. For example, due to large capacitive coupling, the green emission signals may be susceptible to influence causing image content containing yellow to appear nonuniform. However, after staggering timing of the emission signals, the nonuniformity may be fully invisible or partially invisible as depicted by image content 162. In certain embodiments, the anodes 73 may be precharged with a voltage and the timing of the emission signals may be staggered, thereby reducing or eliminating the nonuniformity, as depicted by image content 164. After compensating for capacitive coupling between the anodes 73, the visibility of the image artifacts may be reduced by 50%, 80%, 90%, 100%, and the like. The process for staggering the timing of emission signals will be described in greater detail below.

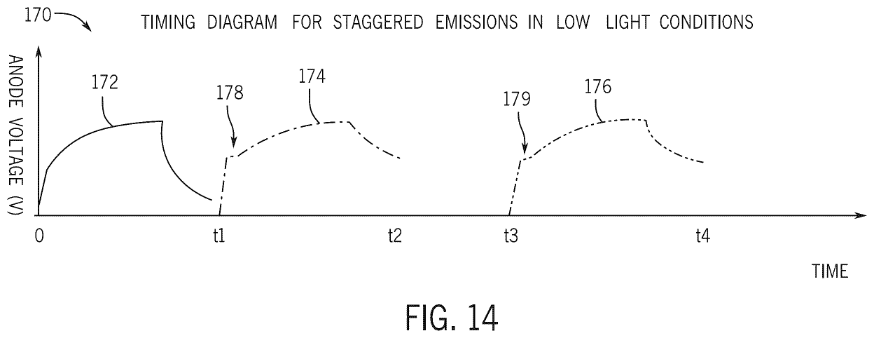

The support circuitry 62 may receive the image data and generate a staggered emission clock signal for each of the red emission signals, the blue emission signals, and the green emission signals. Then, the micro-driver 78 may receive the digital code 70 and program the display pixels 77 to display the image content based on the digital code 70. In certain instances, the digital code 70 may be indicative of low gray levels or low light conditions. As such, the timing of the emission signals may be staggered to reduce or eliminate capacitive coupling. FIG. 14 illustrates a graph 170 illustrating staggering the timing of the red emission signals, the blue emission signals, and the green emission signals based on the digital code 70. For example, the lines 172, 174, and 176 correspond to the red emission signals, the blue emission signals, and the green emission signals, respectively. As illustrated by line 172, the red emission signal may start at time t=0 and end at time t=t1. Then, after a period of time, as illustrated by line 174, the blue emission signal may start at time t=t1 and stop at time t=t2. With the staggered emission timing, at point 178, the line 174 illustrates a small peak, which may be indicative of some voltage transfer between the red emission signal and the blue emission signal. However the amount of voltage transfer may not be substantial, as such that the viewer may not see a luminance shift. Accordingly, image artifacts within the image content may not be present to the viewer.

Then, after a second period of time, the green emission signals may start at time t=t3 and end at time t=t4. At point 179, the line 176 illustrates a slight increase in anode voltage, which may be indicative of some voltage sharing between the green emission signals and the blue emission signals. However, the voltage sharing may not be substantial, as such a luminance shift may not be detected by the viewer. By staggering the timing of emission signals, the emission signals may not overlap and capacitive coupling between the anodes 73 may be reduced.

By way of a non-limiting example, a low light or low gray level conditions of the micro-LED display 12 may have luminance conditions approximately equal to 50 nits. The red emission signals may start at a time t=0 uS and continue for 3.2 uS (or have a pulse width of 3.2 uS). Then, at a time t=5 uS, the blue emission signals may start and have a pulse width of 8.3 uS. In this way, the red emission signal and the blue emission signal may not have overlap. In other words, the blue emission signal may start after the red emission signal. Lastly, the green emission signal may start at a time t=15 uS and may have a pulse width of 21 uS. In this way, the timing of emission signals of the display pixels 77 within the micro-LED display 12 may be staggered and capacitive coupling between the anodes 73 may be reduced or eliminated.

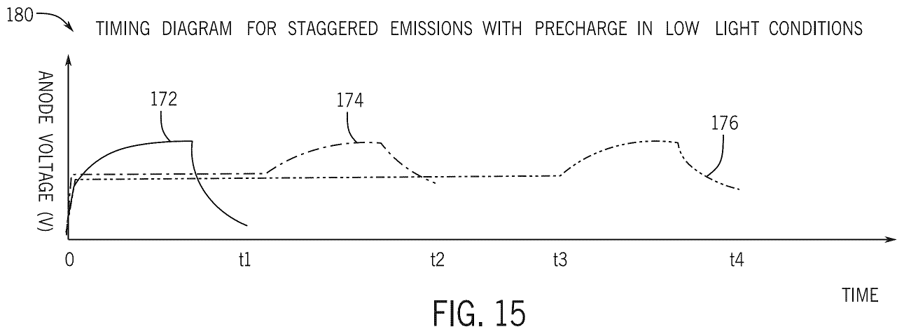

In certain embodiments, the anodes 73 may be pre-charged with a voltage before starting emissions to reduce or eliminate capacitive coupling. FIG. 15 illustrates a graph 180 illustrating staggering the timing of the emission signals and precharging the anodes 73 over time based on the digital code. For example, the lines 172, 174, and 176 correspond to the red emission signals, the blue emission signals, and the green emission signals, respectively. As illustrated by line 172, the anode 73 may not be precharged, rather the anode 73 may drive the display pixels 77 to create the red emission signal at a time t=0 and stop at a time t=t1. As illustrated by line 174, the anode 73 associated with the blue channel may be precharged with a voltage, then the anode 73 may drive the associated display pixels 77 to emit a signal after a period time. As illustrated by line 174, the blue emission signal may start at time t=t2 and end at time t=t3. Due to the precharge, the blue emission signal may not be impacted by charge transfer from the red emission signal, or impact from the red emission signal may be small or negligible in comparison to the precharge voltage.

Further, the anode 73 associated with the green channel may be precharged for a period of time with a voltage. As illustrated by line 176, the anode 73 may be precharged with the voltage from time t=0 to time t=t3. Then, at time t=t3, the anode 73 may drive the display pixels 77 to create green emission signal and ending at a time t=t4. Indeed, line 176 appears smooth, which may be indicative of little or no capacitive charge coupling, or in the case of voltage sharing, the amount of voltage sharing in comparison to the precharge voltage may be small or negligible. In this way, capacitive coupling between the anodes 73 may be reduced or eliminated

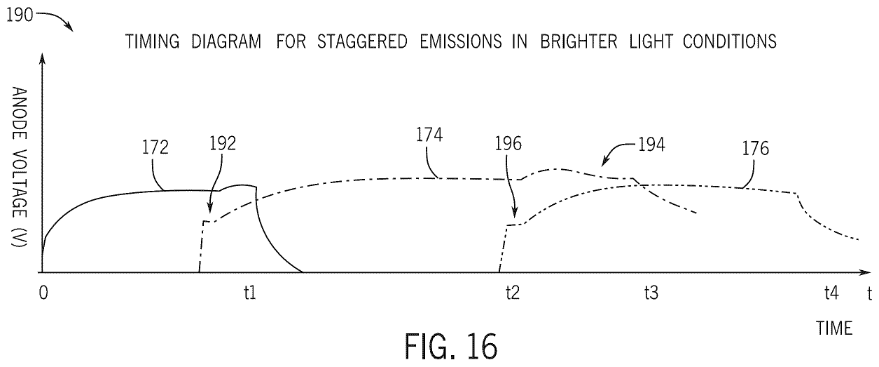

FIG. 16 illustrates a graph 190 illustrating staggered timing of emission signals in brighter light conditions. For example, the pulse width of the emission signals in brighter light conditions may be longer than the pulse width of the emission signals in low light conditions. The graph 190 includes the lines 172, 174, and 176, which correspond to the red emission signal, the blue emission signal, and the green emission signal, respectively, from the anodes 73. As illustrated by line 172, the red emission signal may start at time t=0 and end at time t=t1. After reaching peak anode voltage, the red emission signal may start to decay for a period of time and continue to give off a voltage. The voltage from the red emission signal may impact surrounding anodes 73 that may be emitting light. For example, before time t=t1, as illustrated by line 174, the blue emission signal may start emission and stop emission at time t=t3. At point 192, the blue emission signal may receive stray charge or capacitive coupling from the red emission signal. Indeed, the line 174 illustrates a small peak at point 192, which may be indicative of an increase in anode voltage or capacitive coupling. At time t=t2, as illustrated by line 176, the green emission signal may start and last until time t=t4. There may be overlap between the blue emission signal and the green emission signal, which may cause some capacitive coupling. At point 194, the blue emission signal may receive some voltage from the green emission signal, resulting in a small voltage change. Additionally or alternatively, at point 196, the green emission signal may receive some voltage from the blue emission signal. Indeed, the peaks present at points 192, 194, and 196 may be indicative of capacitive coupling between the emission signals. However, due to the long emission signals in brighter light conditions, some overlap may not cause image artifacts within the image content displayed on the micro-LED display 12, since the length of the emission is much larger than the disturbance to the emission signal due to capacitive coupling.

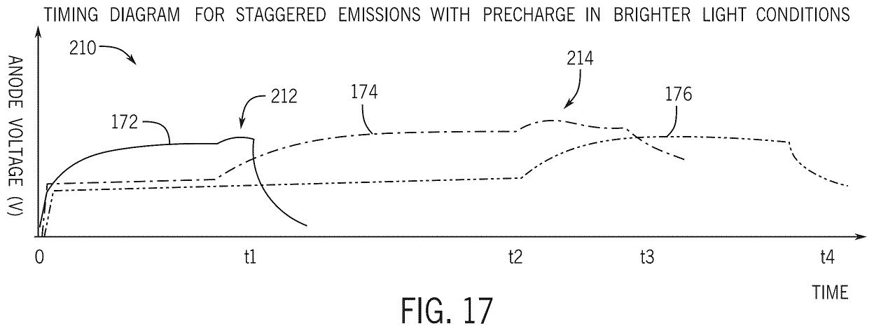

FIG. 17 illustrates a graph 210 illustrating the emission signals for display pixels 77 in which the anodes 73 received precharge in brighter light conditions. For example, the graph 210 includes lines 172, 174, and 176, which correspond to the red emission signal, the blue emission signal, and the green emission signal, respectively. In an embodiment, the blue emission signal and the green emission signal may be precharged with a voltage before being emitted, while the red emission signal may begin emissions at a time t=0.

As illustrated by line 172, the red emission signal may start emissions at time t=0 and stop emissions at time t=t1. Then, as illustrated by line 174, the blue emission signal may start emissions at time t=t1 and stop emissions at time t=t3. Because the blue emission signal starts before the end of the red emission signal, some capacitive coupling may occur. As illustrated by point 212, the red emission signal may receive some voltage from the blue emission signal, which result in a slight increase in anode voltage.

At time t=t2, as illustrated by line 176, the green emission signal may start emissions and stop emissions at time t=t4. The green emission signal and the blue emission signal may slightly overlap in time, which may result in capacitive coupling. At point 214, the blue emission signal may receive some charge transfer from the green emission signal. However, due to the long emission signals and the brighter light conditions, the slight charge transfer between the emission signals may not affect the brightness and/or image content being displayed on the micro-LED display 12.

By way of a non-limiting example, at a brightness of 100 nits and a gray level 255, the emission timing of the display pixels 77 may be slightly staggered. For example, the red emission signals may start at time t=0 and may have a pulse width of 3.2 uS, then the blue emission signals may start at time t=5 uS and may have a pulse width of 16.6 uS, and lastly the green emission signals may start at time t=15 uS and may have a pulse width of 42 uS. The blue emission signals and the green emission signals may slightly overlap, causing some capacitive coupling between the two emission signals. However, with a longer pulse width and brighter conditions, some capacitive coupling may not affect the image content being displayed. The change in emission signal due to charge transfer may be small while the length of the emission is large, as such the change in emission signal may have a negligible impact on the luminance displayed by the display pixel 77. As such, the viewer may not notice a luminance shift due to the brighter light conditions or image artifacts due to the luminance shift.

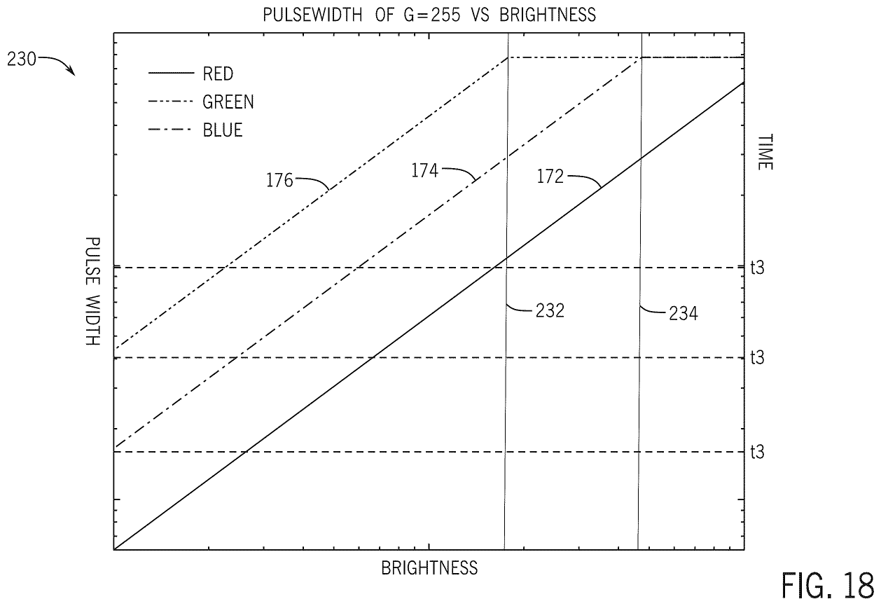

FIG. 18 illustrates a graph 230 illustrating a pulse width of the emission signals over a brightness setting (e.g., nits). For example, the lines 172, 174, and 176 may correspond to the red emission signal, the blue emission signal, and the red emission signal, respectively. As brightness settings increase, the pulse width of the emission signals may also increase, thereby reaching the desired luminance. For example, the red emission signal may immediately start, while the blue emission signal and the green emission signal may receive precharge before emitting. For example, at time t=t1, the blue emission signal may start, while the green emission signal continues to precharge. Then, at time t=t2, the green emission signal may start. The pulse widths of the red emissions, the blue emissions, and the green emissions may continue to increase until a threshold brightness level. Because the green emission signal received precharge, the pulse width of the green emission signal may reach the threshold brightness level before the blue emission signals and the green emission signals. For example, at the point 232, which corresponds to a first brightness level, the pulse width of the green emission signal may level out. Additionally or alternatively, at point 234, which corresponds to a second brightness level, the pulse width of the blue emission signal may not increase. In comparison, the red emission signal may not reach the threshold brightness level due a lack of precharge.

While the illustrated examples describe staggering the timing of the red emission signal, followed by the blue emission signal, followed by the green emission signal, it should be appreciated that the emission signals may be staggered in any order after any period of time. For example, the emission signals may be staggered such that the blue emission signals go first, then the red emission signals, followed by the green emission signals. In another example, the green emission signals may go first, followed by the blue emission signals, and the red emission signals. Furthermore, any of the emission signals may be precharged before emitting, such as the red emission signals, the blue emission signals, or the green emission signals.

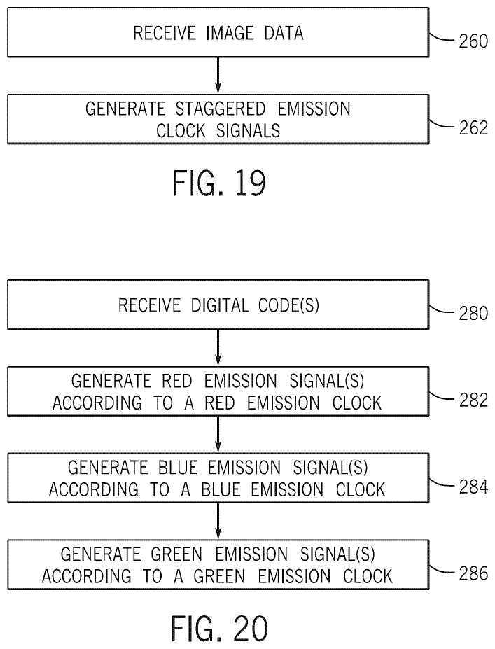

FIG. 19 illustrates a flow diagram that provides a more in-depth discussion of staggering the timing of emission signals of the display pixels 77. While the process of FIG. 19 is described using process blocks in a specific sequence, it should be understood that the present disclosure contemplates that the described process blocks may be performed in different sequences than the sequence illustrated, and certain described process blocks may be skipped or not performed altogether.

At block 260, the driving circuitry (e.g., support circuitry 62) may receive image data. The image data may include a gray level, a luminance, or the like. For example, the image data may indicate a low gray level and short pulse widths for light emissions of the display pixels 77. Since pulse widths are short, it may be beneficial to stagger the emission signals to reduce or eliminate capacitive coupling. In another example, the image data may indicate brighter light conditions with high gray levels. As described herein, the emission signals during brighter light conditions may not be staggered as changes to luminance may be negligible or not visible due to the brighter light conditions.

At block 262, the driving circuitry may generate staggered clock emission signals (EM_CLK). For example, clock emission signals (EM_CLK) may be staggered based on the image data. If the image data includes low gray levels, the driving circuitry may stagger the emission clock signal (EM_CLK) for the red emission signals, the green emission signals, and/or the blue emission signals, respectively. The staggered clock emission signals may be driven across the rows and columns of display pixels to create staggered light emissions.

In low light or low gray level conditions, timing may be flexible since pulse-widths may be shorter. By way of example, a frame of image content may be displayed over 100 uS. The pulse width for a red emission signal may be 3.2 uS, the pulse width of a blue emission signal may be 5.2 uS, and the pulse width of a green emission signal may be 14 uS. Due to staggered clock emission signals (EM_CLK), each emission may be staggered approximately 1-5 uS. As such, image artifacts due to capacitive coupling may be reduced or eliminated.

With the foregoing in mind, FIG. 20 illustrates a flow diagram that provides a more in-depth discussion of staggering the timing of emission signals of the display pixels 77. While the process of FIG. 20 is described using process blocks in a specific sequence, it should be understood that the present disclosure contemplates that the described process blocks may be performed in different sequences than the sequence illustrated, and certain described process blocks may be skipped or not performed altogether.

At block 280, the driving circuitry (e.g., micro-driver 78) may receive the digital code(s) 70 associated with the red emission signals, the blue emission signals, and the green emission signals. The digital code(s) may include the emission clock signals (EM_CLK) created by the support circuitry 62. In certain instances, the emission clock signals may be staggered for each of the red emission signals, the blue emission signals, and the green emission signals, which may be based on the image data. However, the emission clock signals may not be staggered. That is, the emission clock signals may cause the red emission signals, the blue emission signals, and the green emission signals to start at a similar time. The micro-driver 78 may program the digital code(s) onto the display pixels 77.

At block 282, the driving circuitry may cause the display pixels 77 to generate the red emission signals according to the red emission clock. For example, based on the digital code 70 programmed onto the display pixels 77, the display pixels 77 associated with the red channel may display light emissions. In other words, the display pixels 77 may generate the red emission signals according to the red emission clock. Additionally or alternatively, the anodes 73 associated with the blue channel and the green channel may be precharged with a voltage. As such, the display pixels 77 associated with the blue channel and the green channel may not generate light emissions. In other words, the blue emission block and the green emission clock may be staggered such that light emissions may not be generated.

At block 284, the driving circuitry may cause the display pixels 77 to generate blue emission signals according to the blue emission clock. For example, based on the digital code 70 programmed onto the display pixels 77, the display pixels 77 associated with the blue channel may display light emissions. Additionally or alternatively, the anode 73 associated with the green channel may be precharged with a voltage.

At block 286, the driving circuitry may cause the display pixels 77 to generate green emission signals according to the green emission clock. In this way, the timing of the emission signals may be staggered to reduce or eliminate capacitive coupling between the anodes 73.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. An electronic display comprising:
a first anode configured to carry a red emission signal associated with a plurality of red display pixels of the electronic display;
a second anode configured to carry a blue emission signal associated with a plurality of blue display pixels of the electronic display;
a third anode configured to carry a green emission signal associated with a plurality of green display pixels of the electronic display; and
a micro-driver configured to stagger a timing of the red emission signal, the blue emission signal, and the green emission signal based on an emission clock signal to display image content on the electronic display.

2. The electronic display of claim 1, wherein the micro-driver is configured to precharge the second anode and the third anode with a voltage.

3. The electronic display of claim 2, wherein the micro-driver is configured to cause the second anode to emit the blue emission signal and continue to precharge the third anode with the voltage.

4. The electronic display of claim 2, wherein a charge from the red emission signal does not affect the blue emission signal due to the precharge and the staggered timing.

5. The electronic display of claim 4, wherein a charge from the blue emission signal does not affect the green emission signal due to the precharge and the staggered timing.

6. The electronic display of claim 1, wherein the emission clock signal alters a pulse width of the red emission signal, a pulse width of the blue emission signal, and a pulse width of the green emission signal based on a luminance of the image content of the electronic display.

7. The electronic display of claim 6, wherein the micro-driver is configured to increase the pulse width of the blue emission signal and the pulse width of the green emission signal, and wherein the micro-driver is configured to cause the blue emission signal and the green emission signal to overlap due to a higher luminance of the image content.

8. The electronic display of claim 1, wherein the micro-driver is configured to stagger the timing such that the red emission signal, the blue emission signal, and the green emission signal do not overlap.

9. The electronic display of claim 1, wherein the emission clock signal is generated based on an emission clock within the electronic display.

10. A method comprising:
receiving, via support circuitry, image data indicative of a gray level;
generating, via the support circuitry, digital code comprising staggered clock emission signals based on the image data; and
programming, via a micro-driver, display pixels with the digital code to stagger a timing of a first emission signal, a second emission signal, and a third emission signal based on the staggered clock emission signals to display image content.

11. The method of claim 10, comprising:
driving, via the micro-driver, a first set of display pixels associated with a first anode to emit the first emission signal; and
precharing, via the micro-driver, a second anode with a pre-determined voltage during a period of time of the first emission signal.

12. The method of claim 11, comprising:
after the period of time, driving, via the micro-driver, a second set of display pixels associated with the second anode to emit a second emission signal; and
precharing, via the micro-driver, a third anode with the pre-determined voltage.

13. The method of claim 12, wherein the first emission signal and the second emission signal do not overlap.

14. The method of claim 11, wherein the first set of display pixels are configured to emit the first emission signal based on the staggered emission clock signals.

15. An electronic device comprising:
an electronic display configured to display a frame of image data, wherein the electronic display comprises:
a first anode associated with a first set of display pixels of only a first color, wherein the first anode is configured to cause the first set of display pixels to display the first color;
a second anode associated with a second set of display pixels of only a second color, wherein the second anode is configured to cause the second set of display pixels to display the second color;
a third anode associated with a third set of display pixels of only a third color, wherein the third anode is configured to cause the third set of display pixels to display the third color; and
a micro-driver configured to:
receive the image data, wherein the image data comprises an emission control signal comprising a timing delay;
program the first set of display pixels, the second set of display pixels, and the third set of display pixels with the image data; and
drive the first set of display pixels to display the first color based on the image data; and
after a period of time, cause the second set of display pixels to display the second color and the third set of display pixels to display the third color.

16. The electronic device of claim 15, wherein the micro-driver is configured to precharge the second anode and the third anode with a voltage during the period of time.

17. The electronic device of claim 15, wherein the micro-driver is configured to cause the third set of display pixels to display the third color after the second set of display pixels displayed the second color.

18. The electronic device of claim 15, wherein the emission control signal comprises emission clocks for the first set of display pixels, the second set of display pixels, and the third set of display pixels that are staggered.

19. The electronic device of claim 18, comprising driver circuitry configured to receive the image data and generate the emission clocks for the first set of display pixels, the second set of display pixels, and the third set of display pixels that are staggered based on the image data.

20. The electronic device of claim 18, comprising driver circuitry configured to receive the image data and generate the emission clocks for the first set of display pixels, the second set of display pixels, and the third set of display pixels that are not staggered based on the image data.
